(19) United States
(12) Patent Application Publication
(10) Pub. No.: US 2008/0295800 A1
(43) Pub. Date: Dec. 4, 2008

(54) Composite body bore band

(76) Inventor: Kim A. Bolinger, Rochester, NY (US)

Correspondence Address: DELPHI TECHNOLOGIES, INC., M/C 480-410-202, PO BOX 5052, TROY, MI, 48007, US

(21) Appl. No.: 11/809,415

(22) Filed: Jun. 1, 2007

(51) Int. Cl. F02D 9/08

(52) U.S. Cl. 123/337

(57) ABSTRACT

A composite throttle body includes a composite body bore band manufactured out of a durable high-performance composite material that is overmolded with a lower cost commercial grade nylon to form the outer shell of the throttle body. By manufacturing the bore band from a high-performance polyimide-based polymer composite material, such as Vespel™ manufactured by DuPont, a better dimensional stability for improved minimum airflow control is achieved. Furthermore, the high-performance composite material provides the bearing surface for the throttle shaft and, therefore, eliminates the need for separate bearings. By using commercial grade nylon for the majority of the throttle body the manufacturing costs are lowered and weight savings are attained.

### TECHNICAL FIELD

The present invention relates to combustion engine managements systems; more particularly, to engine air control valves and throttle bodies; and most particularly, to a composite body bore band with bearing integration and a method for manufacturing a low-cost composite throttle body.

### BACKGROUND OF THE INVENTION

Engine air control valves having a rotatable valve plate for throttling the flow of air (also known as “butterfly” valves) and throttle bodies housing such valves are well known for metering airflow to an internal combustion engine. An engine air control valve integrated in the throttle body typically opens and closes the passage into an intake manifold to increase or decrease the volume of incoming air. The throttle body/valve assemblies are controlled either mechanically or electronically.

Electronic throttle control bodies are typically designed to provide enhanced powertrain functionality, such as drivability, selectable performance, and cruise and traction control, with fewer components than traditional mechanical throttle systems. Electronic throttle control bodies are typically driven by a DC brush motor and include a throttle position sensor. In the older prior art, electronic throttle control bodies have an aluminum body. Mechanical throttle bodies are typically mechanically linked to an accelerator, offer integrated idle air control and throttle position sensor functions, and are often constructed of aluminum.

In more recent prior art, throttle bodies—electronic and mechanical—are often constructed of composite materials, such as either a thermoplastic or thermoset material. While composite throttle bodies offer increased resistance to corrosion and a significant mass reduction compared to aluminum throttle bodies, typically higher cost materials, such as polyphthalamide (PPA), a high performance polyamid that is a thermoplastic synthetic resin of the nylon family, have to be used rather than, for example, inexpensive commercial grades of nylon, such as Nylon 6 or Nylon 6/6, due to the need for better dimensional stability, temperature performance, chemical resistance, and lower moisture absorption. In some cases a secondary machining operation of the composite body may be required to attain the dimensional control for the bore to valve fit required. Additionally, some composite materials are hygroscopic, which may lead to detrimental effects, such as stress concentration in composite materials. To meet the tight tolerance on the bore to valve fit, aluminum sleeves are included in some composite throttle body designs.

Recently developed polymer materials, such as Vespel™, a trademark of a durable high-performance polyimide-based polymer manufactured by DuPont, combine heat resistance, lubricity, dimensional stability, chemical resistance, and creep resistance but are extremely expensive compared to other available polymers. Unlike most polymers, Vespel™ does not outgas or melt and is not hygroscopic.

To avoid the high manufacturing costs of composite throttle bodies and to obtain the required dimensional stability at the bore to valve interface, some recent prior art designs use additional components, such as an aluminum insert, and mold composite material around it. Due to wear concerns at the shaft to bore interface, shaft bearings, such as ball bearings or needle bearings, are typically used in connection with the aluminum insert, which complicates the assembly process.

What is needed in the art is a low cost solution for composite throttle bodies that have required dimensionally stability, temperature capability and performance characteristics and are relatively easy to assemble. It would further be desirable to eliminate the need for secondary bore machining and the need for shaft bearings.

### SUMMARY OF THE INVENTION

Briefly described, a composite throttle body in accordance with the present invention includes a composite body bore band manufactured out of a durable high-performance composite material, such as a polyimide-based polymer, that is overmolded with a lower cost commercial grade nylon. Contrary to the prior art, where the throttle bodies are either manufactured out of a relative expensive composite material or include an aluminum insert, the composite bore band in accordance with the present invention provides the required dimensional stability needed to attain the dimensional control for the bore to valve fit required. By manufacturing the bore band from a durable high-performance composite material, such as Vespel™ manufactured by DuPont, a better dimensional stability for improved minimum airflow control is achieved and the need for secondary bore machining or aluminum bore inserts is eliminated. Furthermore, the high-performance composite material provides the bearing surface for the throttle shaft and, therefore, eliminates the need for bearings used in the prior art. The composite throttle body may be, for example, an electronic throttle control body, a mechanical throttle body, or a diesel electronic throttle control body housing, for use with, for example, an electronic throttle control valve, a mechanical throttle body valve, or a diesel intake throttle body valve.

In accordance with the present invention, the composite body bore band is overmolded with lower cost commercial grade nylon, such as Nylon 6 or Nylon 6/6. By using commercial grade nylon for the majority of the throttle body, the manufacturing costs of the throttle body are lowered compared to prior art composite throttle bodies. Furthermore, using nylon for the majority of the throttle body enables integration between nylon manifolds and throttle bodies, which may not be possible with prior art composite throttle bodies due to the use of two dissimilar materials. Throttle body and manifold integration eliminates several components and a potential leak path between the throttle body and the manifold improving reliability and reducing labor for assembly and manufacturing costs.

### BRIEF DESCRIPTION OF THE DRAWINGS

The present invention will now be described, by way of example, with reference to the accompanying drawings, in which:

FIG. 1 is an exploded isometric view of a prior art multi-piece composite throttle body with aluminum insert for valve to bore area;

FIG. 2 is an exploded isometric view of a prior engine air control valve assembly of the composite throttle body shown in FIG. 1;

FIG. 3 is an isometric view of a single-piece electronic throttle control body;

FIG. 4 is a longitudinal cross-sectional view taken along line 4-4 in FIG. 3;

FIG. 5 is an isometric view of a composite body bore band;

FIG. 6 is a schematic plan front view of a another aspect of a composite body bore band; and

FIG. 7 is a cross-sectional view taken along line 7-7 in FIG. 6.

Corresponding reference characters indicate corresponding parts throughout the several views. The exemplification set out herein illustrates one preferred embodiment of the invention, in one form, and such exemplification is not to be construed as limiting the scope of the invention in any manner.

### DESCRIPTION OF THE PREFERRED EMBODIMENTS

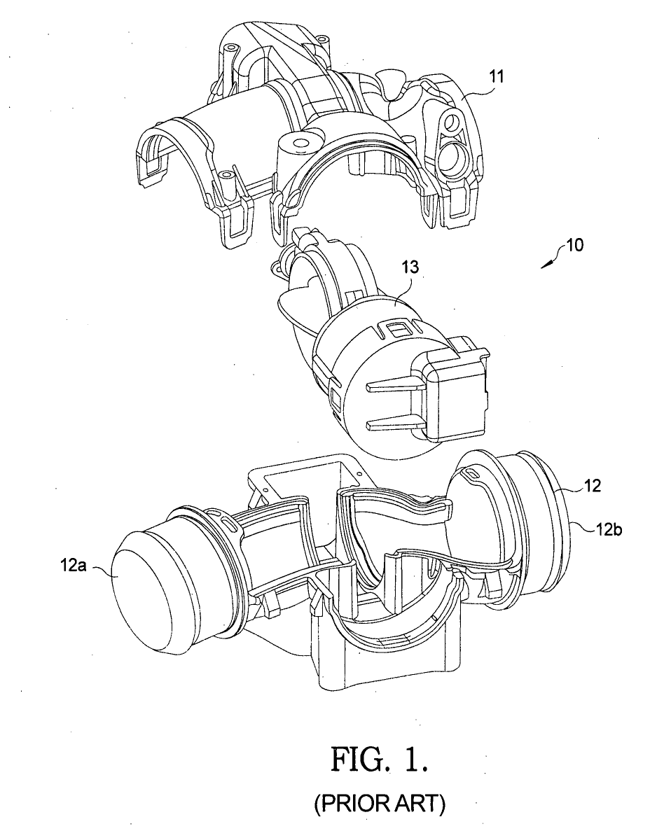

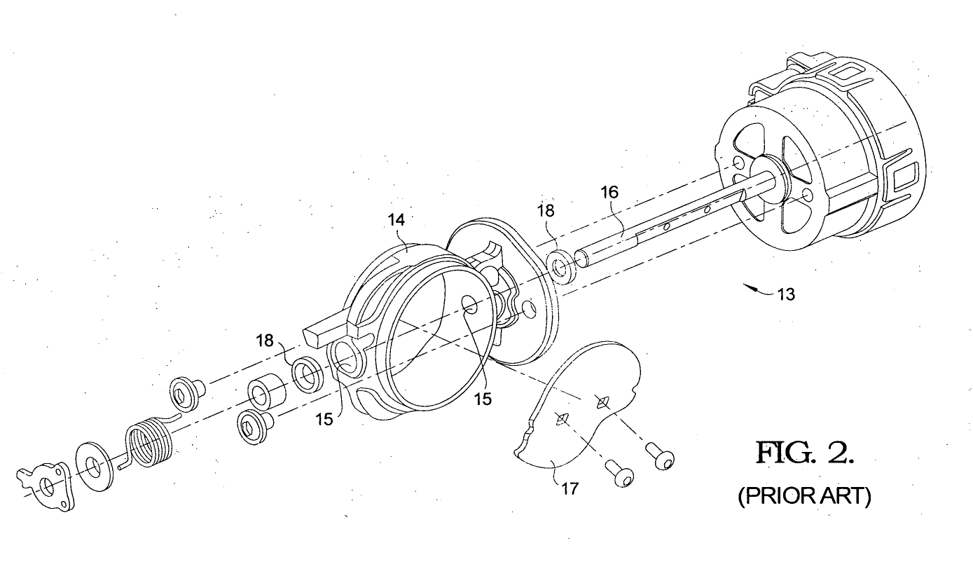

Referring to FIGS. 1 and 2, a conventional composite throttle body 10 includes an upper shell 1 1, a lower shell 12, and a valve assembly 13 housed between the upper shell 11 and the lower shell 12. Lower shell 12 includes air inlet and outlet 12a, 12b. When assembled within the upper and lower shell, valve assembly 13 controllably opens and closes the air passage between the inlet and outlet to increase and decrease the volume of incoming air to the engine. The upper shell and the lower shell are typically manufactured from a composite material, which may be either a thermoplastic or thermoset material, such as polyphthalamide (PPA). The valve assembly 13 includes an aluminium member 14 having bores 15 that receive a throttle shaft 16. A rotatable valve plate 17 is mounted to the shaft 16 and housed by the aluminum member 14. Bearings 18, such as ball bearings or needle bearings, are inserted into the bores 15 for rotation of the shaft 16 in the bores 15 and to attain dimensional control for the bore 15 to valve 17 fit required for minimum airflow control when the valve is in a closed or a near closed position.

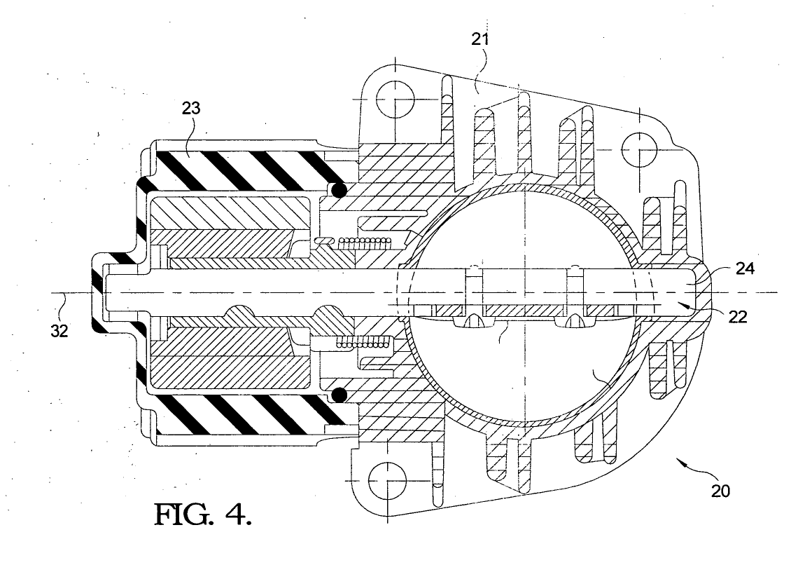

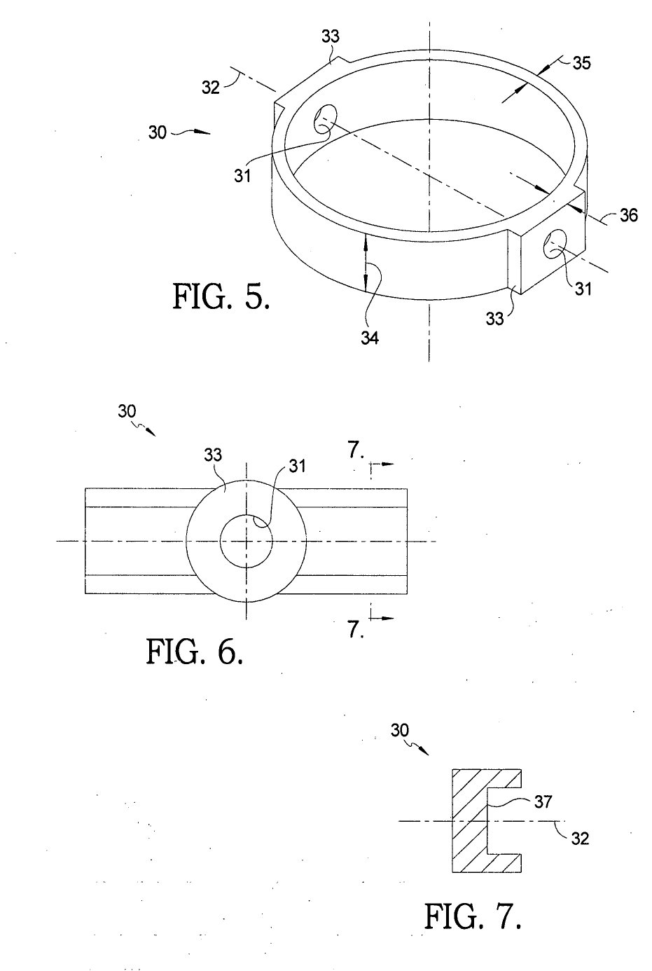

The novelty disclosed herein, which is the subject of the present invention, is replacing aluminum valve 14 with a composite body bore band 30 (shown in detail in FIG. 5), which is manufactured from a durable high-performance composite material, such as Vespel™ manufactured by DuPont. The high-performance composite material is used as bearing surface for the throttle shaft 16 eliminating the need for separate bearings 18 and simplifying the assembly. By overmolding the composite body bore band 30 with lower cost commercial grade nylon, manufacturing costs and labor for assembly are lowered and weight savings are achieved compared to the prior art multi-piece composite throttle body assembly 10 or prior art throttle body assemblies machined entirely from a cast metal such as aluminum.

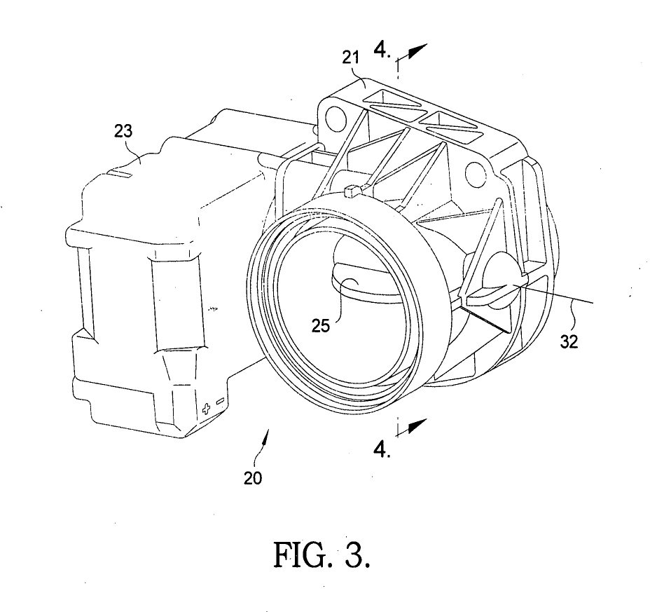

Referring to FIGS. 3, 4 and 5, single-piece electronic throttle control body 20 includes an outer shell 21, a composite body bore band 30, a valve assembly 22, and an electric motor 23. The electric motor 23 is provided with a throttle position sensor (not shown). The valve assembly 22 includes a throttle shaft 24 having a valve plate 25 attached and being driven by electric motor 23. The bore band 30 includes bores 31 that receive and support the throttle shaft 24. The bore band 30 encircles the valve plate 25. It is understood that electronic throttle control body 20 is provided for purpose of description only and the invention is not limited to the particular throttle body design shown in the figures. Rather, the invention is applicable to any throttle body design—electronic or mechanical—and any type of engine air control valve, which could benefit from the advantages the present invention offers as further explained below.

Bore band 30, shown also in FIGS. 5 through 7, is formed as a separate part during, for example, a molding process, such as injection molding, of a durable high-performance polymer composite material, such as Vespel™ manufactured by DuPont. Bore band 30 is then overmolded with commercial grade nylon, such as Nylon 6 or Nylon 6/6 to form outer shell 21. Durable high-performance polyamide-based polymers, such as Vespel™, combine heat resistance, lubricity, dimensional stability, chemical resistance, and creep resistance and, therefore, the bore band 30 provides the dimensional stability needed for bore 31 to valve 24 interface while lowering the overall cost of the electronic throttle control body 20. Furthermore, due to the performance characteristics of the polymer material used for the bore band 30, the bores 31 integrated in the bore band 30 do not need secondary machining or aluminum sleeves to meet the tolerance on the bore to valve fit, as do prior art composite throttle bodies. Still further, the durable high-performance composite material of the bore band 30 is utilized in one aspect of the invention as bearing surface for the throttle shaft 24 eliminating the need for separate bearings.

Overmolding the bore band 30 with a low-cost commercial grade nylon may also allow integration between conventional nylon manifolds (not shown) and composite electronic throttle control bodies 20, since the outer shell 21 can be manufactured from the same nylon material as conventional nylon manifolds. Composite electronic throttle control body 20 and conventional nylon manifold integration enables elimination of components typically used to connect the manifold with the throttle body, such as gasket, bolts, inserts, simplifies the assembly, and improves reliability. Furthermore, a potential leak path between the composite electronic throttle control body 20 and the conventional nylon manifold is eliminated by integration.

Referring to FIG. 5, bore band 30 is manufactured as a single piece and includes two bores 31 positioned opposite from each other and centered along an axis 32. The surface of the bores 31 is used as bearing surface for the throttle shaft 24 (shown in FIG. 4). Bore band 30 may be a ring of constant thickness 35 around the perimeter, as shown in FIG. 5. Bore band 30 may include two bosses 33 that are positioned in the area of the bores 31. The bosses 33 extend outward to provide a larger bearing surface for throttle shaft 24. The bosses 33 may have a square shape, as shown, or be of any shape to complement the purpose of bore band 30, in accordance with the invention. The diameter of the bore band 30 is selected according to the size of the valve plate 17 that is rotated within the bore band 30. The diameter of the bores 31 is selected according to the shaft 24 that extends through the bores 31. The height 34 of the bore band, the thickness 35, and the width 36 of the extending boss 33 is selected to provide the dimensional stability needed to attain the required bore 31 to valve 24 fit.

Referring to FIGS. 6 and 7, an alternate embodiment of the bore band 30 is illustrated. Bore band 30 may be a ring of irregular thickness around the perimeter. For example, the cross-section of the bore band 30 may have, but is not limited to, the shape of a “C”, as shown in FIG. 7. By utilizing the irregular “C” shape, material savings are achieved by using less of the expensive high-performance composite material. The gap 37 is filled with less-expensive commercial grade nylon during the overmolding process. Furthermore, the extending bosses 33 may have a circular shape that includes the bores 31 in the center. Such design selections and modifications are well within the abilities of those skilled in the art.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A throttle body, comprising:
a composite body bore band; and
an composite outer shell molded over said bore band.

2. The throttle body of claim 1, wherein said bore band is formed of a durable high-performance polymer composite material.

3. The throttle body of claim 1, wherein said outer shell is formed of commercial grade nylon.

4. The throttle body of claim 1, further including a valve assembly, wherein said valve assembly includes a throttle shaft having a valve plate attached.

5. The throttle body of claim 4, wherein said bore band encircles said valve plate.

6. The throttle body of claim 4, wherein said bore band receives and supports said throttle shaft.

7. The throttle body of claim 4, wherein said bore band provides a bearing surface for said throttle shaft.

8. The throttle body of claim 1, wherein said bore band is a single piece.

9. The throttle body of claim 1, wherein said bore band provides dimensional stability for said throttle body.

10. The throttle body of claim 1, wherein said outer shell integrates with a manifold formed of the same material as said outer shell.

11. A composite body bore band, comprising:
a ring having a thickness around the perimeter;
two bores positioned in the center of said ring and opposite from each other; and
two outward extending bosses positioned in the area of said bores.

12. The composite body bore band of claim 11, wherein said ring is manufactured from a high-performance polyimide-based polymer composite material.

13. The composite body bore band of claim 11, wherein the surface of each of said two bores is a bearing surface.

14. The composite body bore band of claim 11, wherein said ring has a constant thickness around the perimeter.

15. The composite body bore band of claim 11, wherein said ring has an irregular thickness around the perimeter.

16. The composite body bore band of claim 11, wherein said bosses have a square shape and extend over the entire height of said ring.

17. The composite body bore band of claim 11, wherein said bosses have a circular shape.

18. A method for manufacturing a low-cost composite throttle body, comprising the steps of:
manufacturing a bore band from a high-performance polyimide-based polymer composite material; and
overmolding said bore band with a low-cost commercial grade nylon material to form said throttle body.

19. The method of claim 18, further including the step of realizing dimensional stability needed for a bore to valve interface for minimum air flow with said bore band.

20. The method of claim 18, further including the step of utilizing said high-performance polyimide-based polymer composite material as bearing surface.
